(19) United States
(12) Patent Application Publication
(10) Pub. No.: US 2006/0163058 A1
(43) Pub. Date: Jul. 27, 2006

(54) Apparatus for plating a semiconductor wafer and plating solution bath used therein

(76) Inventor: Kiyonori Watanabe, Tokyo (JP)

Correspondence Address: RABIN & Berdo, PC, 1101 14TH STREET, NW, SUITE 500, WASHINGTON, DC, 20005, US

(21) Appl. No.: 11/041,955

(22) Filed: Jan. 26, 2005

(51) Int. Cl. B23H 3/04; C25D 17/04

(52) U.S. Cl. 204/286.1; 204/297.01

(57) ABSTRACT

A plating apparatus includes a plating solution bath which is capable to contain a plating solution therein; a holding mechanism which is capable to hold a wafer so that a processing surface is soaked in the plating solution, contained in the plating solution bath; a first electrode provided in the plating solution bath; an inflow port from which the plating solution is supplied into the plating solution bath so that the plating solution flows through the first electrode toward the wafer; and a power supply which is capable to supply an electric current to be flowing through the plating solution located between the first electrode and wafer. The plating solution bath comprises a projected inner wall portion, arranged between the first electrode and the wafer, to control an electric field forwarding to the wafer. The projected inner wall portion is formed as a part an inner wall of the plating solution bath.

### TECHNICAL FIELD OF THE INVENTION

The present invention relates to semiconductor manufacturing apparatuses which fabricate semiconductor devices on a wafer. In particular, it relates to a semiconductor manufacturing apparatus capable forming fine bump electrodes, circuit wiring, or the like by electroplating at high accuracy and high uniformity and to a method for manufacturing a semiconductor device.

### BACKGROUND OF THE INVENTION

Recent trends toward higher integration of semiconductor devices require semiconductor-packaging techniques that can achieve higher densities. Examples of the semiconductor packaging technique include a wire-bonding technique, a TAB technique, and a flip-chip assembly technique. Among these, the flip-chip assembly technique has been widely used to package semiconductor devices, such as computer components, at high densities since this technique achieves packaging at the highest density.

In electroplating process, it is significant to ensure the quality of a plated coating and the uniformity of a plated coating thickness on a surface of the workpiece (wafer) in order to control the quality of semiconductors or the like to be manufactured. For example, in a step of copper plating on a surface of a semiconductor wafer, a conductive seed layer, which makes a cathode for electrolytic plating and also a seed for plating, is previously formed on the pertinent surface.

The processing wafer surface on which the seed layer is formed is soaked in a plating solution bath so to come into contact with, for example, a copper sulfate based plating solution. And, electrical conductors (cathode contacts which will be simply called contacts) are contacted to the seed layer via an outer periphery (peripheral edge) of the wafer to supply an electric current for the electrolytic plating. In the plating solution bath, an anode electrode made of, for example, phosphorus-containing copper is disposed in a state soaked in the plating solution.

Employing the above configuration, an electric current is supplied between the cathode and the anode electrode to make reduction deposition of copper on the cathode, which was initially the seed layer, thereby plating copper on the seed layer.

According to conventional technology, it is difficult to make a plated coating thickness be uniform entirely on a surface of a wafer. As a result, it get more difficult to form fine bump electrodes, circuit wiring, or the like on a semiconductor wafer at high accuracy and high uniformity.

### OBJECTS OF THE INVENTION

Accordingly, it is an object of the present invention to provide an apparatus by which a plated coating thickness is uniform entirely on a surface of a wafer.

Additional objects, advantages and novel features of the present invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

According to a first aspect of the present invention, a plating apparatus includes a plating solution bath which is capable to contain a plating solution therein; a holding mechanism which is capable to hold a wafer so that a processing surface is soaked in the plating solution, contained in the plating solution bath; a first electrode provided in the plating solution bath; an inflow port from which the plating solution is supplied into the plating solution bath so that the plating solution flows through the first electrode toward the wafer; and a power supply which is capable to supply an electric current to be flowing through the plating solution located between the first electrode and wafer. The plating solution bath comprises a projected inner wall portion, arranged between the first electrode and the wafer, to control an electric field forwarding to the wafer. The projected inner wall portion is formed as a part of an inner wall of the plating solution bath in a united body (a solid body), for example, in a monoblock casting process.

An electric field forwarding to an outer peripheral (peripheral edge) of a semiconductor wafer is interrupted or cut off by the projected inner wall. As a result, the amount of metal ions forwarding to the outer peripheral (peripheral edge) of the semiconductor wafer is reduced, and therefore; a uniform thickness of plating can be realized over the entire surface of the semiconductor wafer.

According to a second aspect of the present invention, a plating apparatus includes a plating solution bath which is capable to contain a plating solution therein; a holding mechanism which is capable to hold a wafer so that a processing surface is soaked in the plating solution, contained in the plating solution bath; a disk shape of anode electrode provided in the plating solution bath; an inflow port from which the plating solution is supplied into the plating solution bath so that the plating solution flows through the anode electrode toward the wafer; and a power supply which is capable to supply an electric current to be flowing through the plating solution located between the anode electrode and wafer. The anode electrode has an effective diameter, actually functioning as an electrode, which is smaller than an inner diameter of the plating solution bath.

An electric field between the anode electrode and an outer peripheral (peripheral edge) of the semiconductor wafer is larger than that between the anode electrode and the center of the semiconductor wafer. As a result, the amount of metal ions forwarding to the outer peripheral (peripheral edge) of the semiconductor wafer is reduced, and therefore; a uniform thickness of plating can be realized on the entire surface of the semiconductor wafer.

The present invention is applicable to a wafer-level chip-size package (W-CSP).

### BRIEF DESCRIPTION OF THE DRAWINGS

FIG. 1 is a cross-sectional view illustrating a WCSP (Wafer-level Chip Size Package), which can be fabricated by the present invention;

FIGS. 2A-2F are cross-sectional views showing fabrication steps of the WCSP, shown in FIG. 1;

FIG. 3 is a conceptual diagram (cross section) illustrating a plating apparatus, to which the inventions technology can be applied;

FIG. 4 is a cross sectional view showing a plating solution bath according to a first preferred embodiment of the present invention;

FIG. 5 is a cross sectional view showing a plating solution bath according to a second preferred embodiment of the present invention;

FIG. 6 is a cross sectional view showing a plating solution bath according to a third preferred embodiment of the present invention; and

FIG. 7 is a cross sectional view showing a plating solution bath according to a fourth preferred embodiment of the present invention.

### DETAILED DISCLOSURE OF THE INVENTION

In the following detailed description of the preferred embodiments, reference is made to the accompanying drawings which form a part hereof, and in which is shown by way of illustration specific preferred embodiments in which the inventions may be practiced. These preferred embodiments are described in sufficient detail to enable those skilled in the art to practice the invention, and it is to be understood that other preferred embodiments may be utilized and that logical, mechanical and electrical changes may be made without departing from the spirit and scope of the present inventions. The following detailed description is, therefore, not to be taken in a limiting sense, and scope of the present inventions is defined only by the appended claims.

The substrate for plating used in the present invention is a semiconductor wafer composed of single crystals of Si, GaAs, or the like. Typically, the substrate has a process surface for plating onto which a conductive film, such as a base electrode, is formed so that a plating layer, such as a bump electrode or a circuit wiring, can be formed on the conductive film by electroplating.

In the present invention, the electroplating solution used for plating is a typical electroplating solution, such as a copper sulfate plating solution or an organic acid solder plating solution. By conducting electroplating using these solutions, a plating film composed of copper, solder, or the like for forming a bump electrode, metal wiring for multilevel interconnection, or the like is formed on the conductive film disposed on the process surface of the substrate.

At least the inner walls of the process bath (bath) used in the present invention are composed of a material stable against the electroplating solution. Examples of such a material include fluorocarbon resins, poly-olefins, polyamides, polyesters, poly-ethers, and vinyl chlorides. For example, the process bath has a cylindrical interior with an inner diameter larger than the diameter of the substrate.

In order to electroplate the substrate in this process bath, the substrate must be supported by a substrate-supporting unit so that the process surface of the substrate is held at the same level as the level of the electroplating solution. An example of the substrate-supporting unit is a side pin. Alternatively, the electrode may be used to support the substrate.

In the present invention, the anode electrode is disposed between a jet flow port and a liquid-flow controlling board. A conducting unit, such as a base electrode, is formed on the process surface of the substrate functioning as the cathode. When voltage is applied between the electrodes, cations in the electroplating solution migrate toward the process surface of the substrate to form a plating solution-diffusion layer. The cations in the plating solution-diffusion layer are reduced at the conducting unit on the process surface, and a plating film is formed on the conductive unit of the substrate as a result.

The material of the anode electrode is preferably selected according to the type of electroplating solution used. For example, when a copper sulfate plating solution is used as the electroplating solution, a copper plate containing 0.03 to 0.08 wt % of phosphorus is used as the anode electrode. When an organic acid solder plating solution is used, a high-purity solder plate having a tin content and a lead content corresponding to those in the plating solution is used as the anode electrode so that contamination of the plating film by the anode electrode can be prevented and change in the composition of the plating film to be formed can be prevented.

The anode electrode is preferably a meshed plate with holes so as not to obstruct the flow of electroplating solution jetted from the jet flow port. When the anode electrode is arranged to allow all the electroplating solution jetted from the jet flow port to pass through these holes, the anode electrode functions as a baffle and the electroplating solution is agitated. This leads to homogeneous ionic concentration in the plating solution contained in the process bath. When the diameter of each hole is less than the minimum interval of the resist pattern and the total number of the holes is greater than the total number of the resist-coated sections to be formed on the process surface through the above-described resist pattern, the plating solution can be more thoroughly agitated.

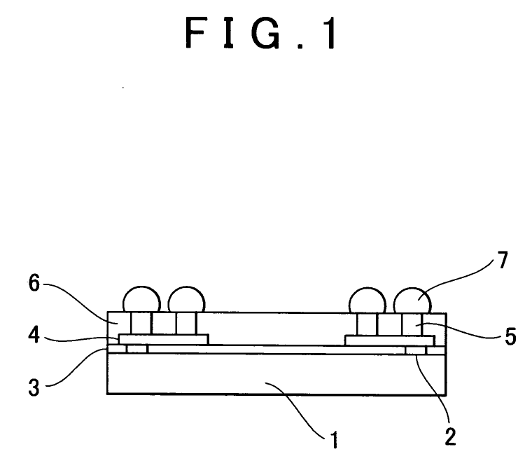

FIG. 1 is a cross-sectional view illustrating a WCSP (Wafer-level Chip Size Package), which can be fabricated by the present invention. A WCSP includes a semiconductor chip 1, aluminum electrode pads 2, an interlayer-insulating layer 3, a conductive (wiring) layer 4, copper electrodes 5, a molding resin 6 and solder balls 7. The aluminum electrode pads 2 are formed on a circuit-forming surface of the semiconductor chip 1. The interlayer-insulating layer 3 is formed on the semiconductor chip 1 entirely except on the aluminum electrode pads 2. The conductive layer 4 is formed so as to connect the aluminum electrode pads 2 and the copper electrodes 5 to each other. The solder balls 7 are formed on the copper electrodes 5 and are to be functioning as external terminals.

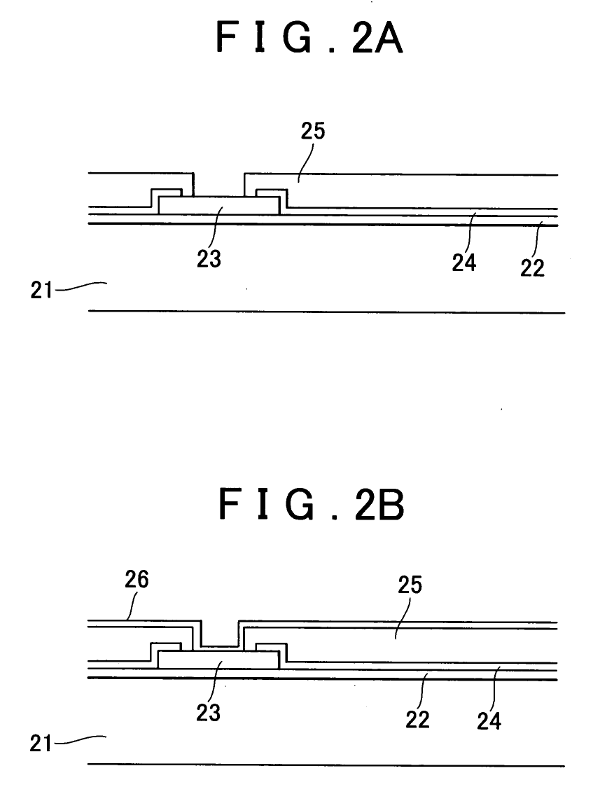

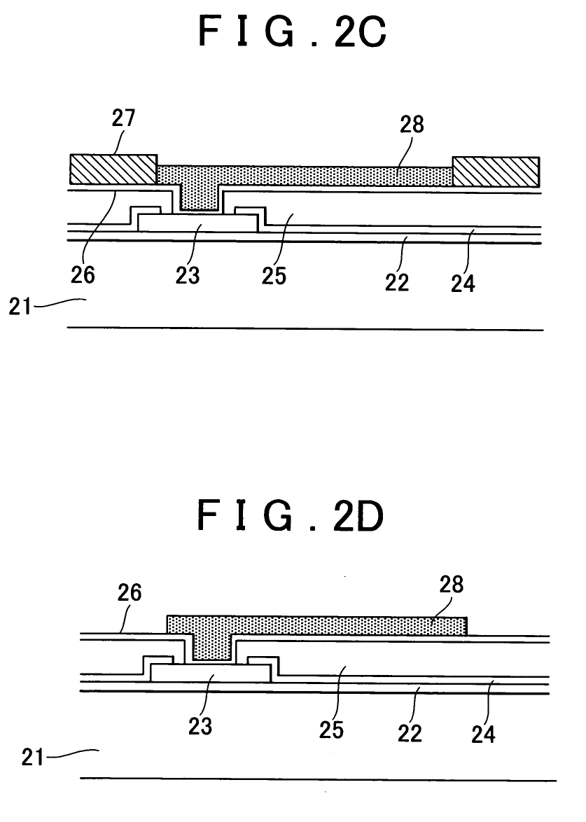

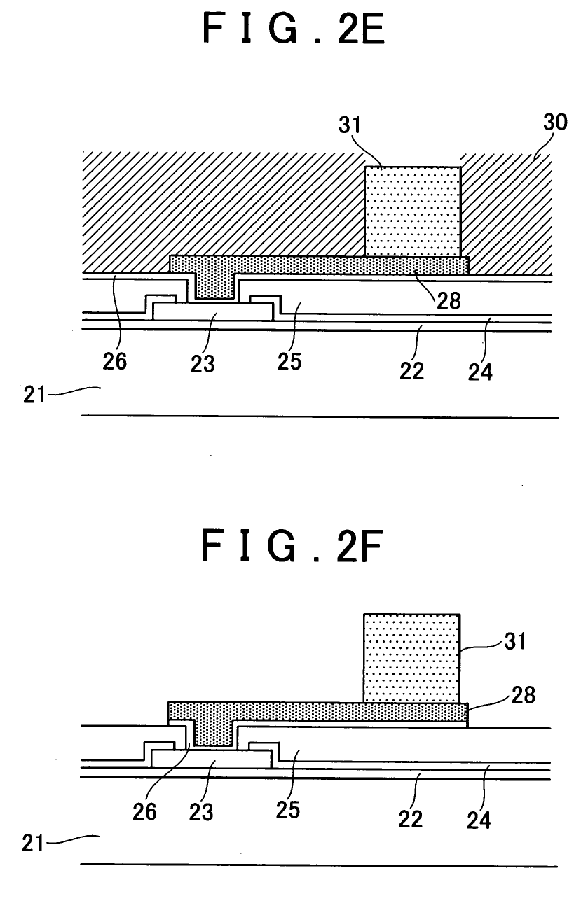

FIGS. 2A-2F are cross-sectional views showing fabrication steps of the WCSP, shown in FIG. 1. As shown in FIG. 2A, an aluminum electrode pad 23 is formed on an oxide layer 22, which is formed on a semiconductor substrate 21. Next, a surface protection layer 24 is formed over the aluminum electrode pad 23 and the oxide layer 22, then, a thorough hole is formed above the aluminum electrode 23. After that, an interlayer-insulating layer 25 is formed over the entire structure, and a through hole is formed above the aluminum electrode 23.

Next, as shown in FIG. 2B, a metal layer 26 is formed over the structure by a sputtering process or the like. After that, as shown in FIG. 2C, a photosensitive resin 27 is formed on the entire surface of the metal layer 26, and a hole is formed in the photosensitive resin 27 at a certain area, where a copper post electrode (31) is to be formed thereon. Next, a wiring layer 28 is formed on the metal layer 26 by electro-deposition of copper in an electroplating process using the metal layer 26 as a common electrode so that a copper post electrode (31) can be formed not straight above the aluminum electrode pad 23.

Subsequently, as shown in FIG. 2D, the photosensitive resin 27 is removed using an extraction solution. After that, as shown in FIG. 2E, another photosensitive resin 30 is formed on the metal layer 26 and wiring layer 28, and a hole is formed at an area where a copper post electrode (31) is formed. Next, a copper post electrode 31 is formed on the wiring layer 28 by electro-deposition of copper in an electroplating process using the metal layer 26 as a common electrode.

As shown in FIG. 2F, the photosensitive resin 30 is removed using an extraction solution, and then, a part of the metal layer 26, which is not covered with the wiring layer 28 or the copper post electrode 31, is removed in an etching process.

The wiring layer 28 and copper post electrode 31 are usually formed by an electroplating process of copper sulfate using a plating apparatus with a jet flow structure.

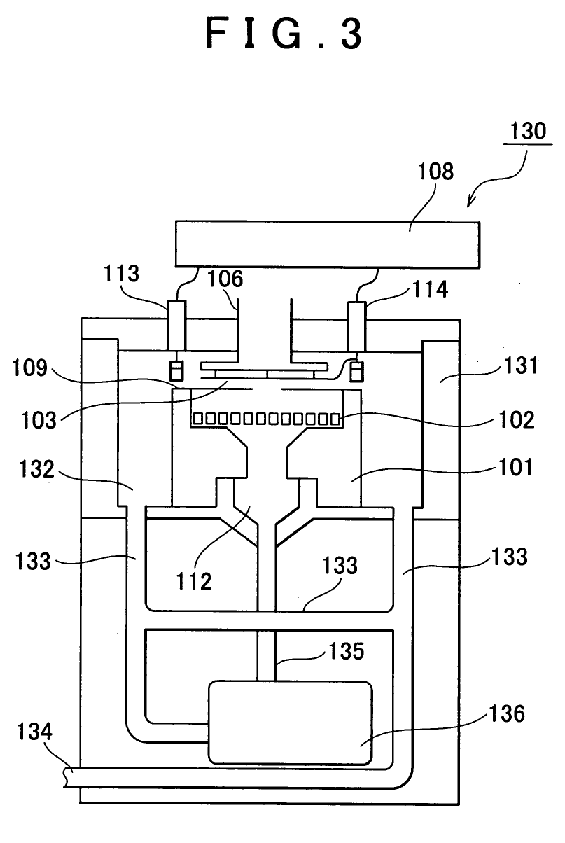

FIG. 3 is a conceptual diagram (cross section) illustrating a plating apparatus 130, to which the inventions technology can be applied. This apparatus 130 is of a type that allows circulation of the electroplating solution.

In the drawing, a plating solution bath 101 is disposed in a plating solution vessel 131. An outer wall of the plating solution bath 101 and an inner wall of the plating solution vessel 131 define a channel 132. A bottom part of the channel 132 is connected to an entry side of a pump 136 via a pipe 133. The pipe 133 is connected to a pipe 134 for supplying an electroplating solution to a semiconductor manufacturing apparatus 130. An exit side of the pump 136 is connected to a jet flow port 112 via a pipe 135.

The inner walls of the plating solution vessel 131, the channel 132, and the pipes 133, 134, and 135 are normally composed of fluorocarbon resins, polyolefins, polyamides, polyesters, polyethers, or vinyl chlorides. The pump 136 is normally a magnet pump having high corrosion resistance, for example. A revolution speed of the pump 136 is controlled by an inverter.

The circulation of the plating solution in the semiconductor manufacturing apparatus 130 will now be described.

The electroplating solution is first fed from the pipe 134, travels through the pipe 133, reaches the pump 136, and jetted into the plating solution bath 101 through the pipe 135. Once the plating solution bath 101 is filled with the electroplating solution, excess electroplating solution is discharged from a discharge section 109 of the bath 101 and returns to the pump 136 via the channel 132 and the pipe 133. Thereafter, supply of the electroplating solution from the pipe 134 is discontinued, and the electroplating solution is circulated within the semiconductor manufacturing apparatus 130.

Reference numeral 108 represents a power supply; 113 and 114 represent an anode pin and a cathode pin, respectively; and 106 represents a wafer supporting mechanism. The wafer supporting mechanism 106 holds a wafer 103 so that a processing surface of the wafer is soaked in the plating solution. The power supply 108 supplies an electric current to be flowing through the plating solution located between an anode electrode 102 and the wafer 103.

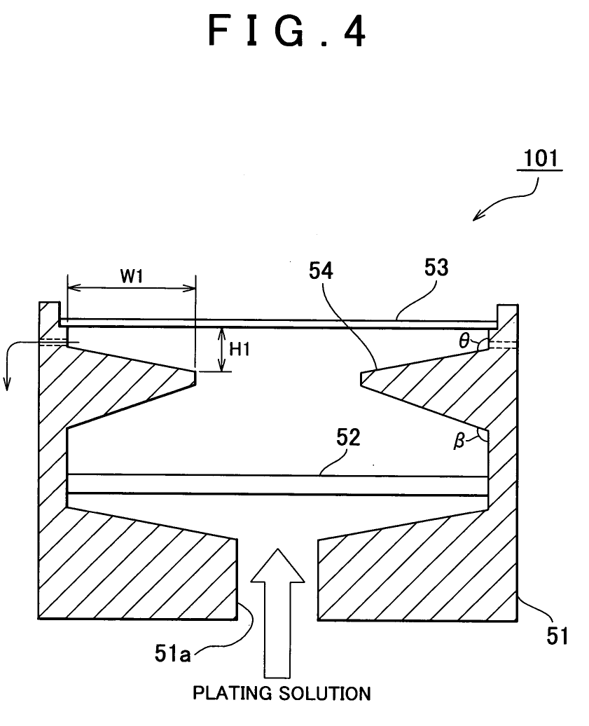

FIG. 4 is a cross sectional view showing a plating solution bath (plating cup) according to a first preferred embodiment of the present invention. A plating solution bath 101 is capable to contain a plating solution therein. The plating solution bath 101 includes a main body 51, an inflow port (jet flow port) 51a, and a projected inner wall portion 54. The projected inner wall portion 54 is arranged between an anode electrode (first electrode) 52 and a semiconductor wafer 53, to control an electric field forwarding to the semiconductor wafer 53. The projected inner wall portion 54 is formed as a part an inner wall of the plating solution bath 101 in a united body, for example, in a monobloc casting process. The plating solution is supplied from the inflow port 51a into the plating solution bath so that the plating solution flows through an anode electrode 52 toward a semiconductor wafer 53.

The projected inner wall portion 54 is shaped to be tapered so that angles θ and β formed between the projected inner wall 54 and a vertical portion of the inner wall of the plating solution bath 101 is larger than 90 degrees. The angles θ and β may be 105 to 120 degrees. A vertical distance H1 from an open end of the projected inner wall 54 to the wafer is about 15% of a diameter of the semiconductor wafer 53. If the diameter of the wafer 53 is about 200 mm, the distance H1 could be about 30 mm.

A projecting width (length) W1 of the projected inner wall 54 is about 10% of a diameter of the wafer 53. If the diameter of the wafer 53 is about 200 mm, the width W1 could be about 20 mm.

The main body 51 can be made of a synthetic resin called polytetrafluoroethylene (Teflon) or polyvinyl chloride. The anode electrode 52 can be made of a phosphorus-containing copper or platinum. The wafer 53 is functioning as a cathode electrode in a plating process.

According to the above-described first preferred embodiment, an electric field forwarding to the outer peripheral (peripheral edge) of the semiconductor wafer 53 is interrupted or cut off by the projected inner wall 54. As a result, the amount of metal ions forwarding to the outer peripheral (peripheral edge) of the semiconductor wafer 53 is reduced, and therefore; a uniform thickness of plating can be realized on the entire surface of the semiconductor wafer 53. Further, the projected inner wall portion 54 is shaped to be tapered, so that the wafer 53 is prevented from having air babbles on the surface thereof, which is usually obstructive against uniform plating.

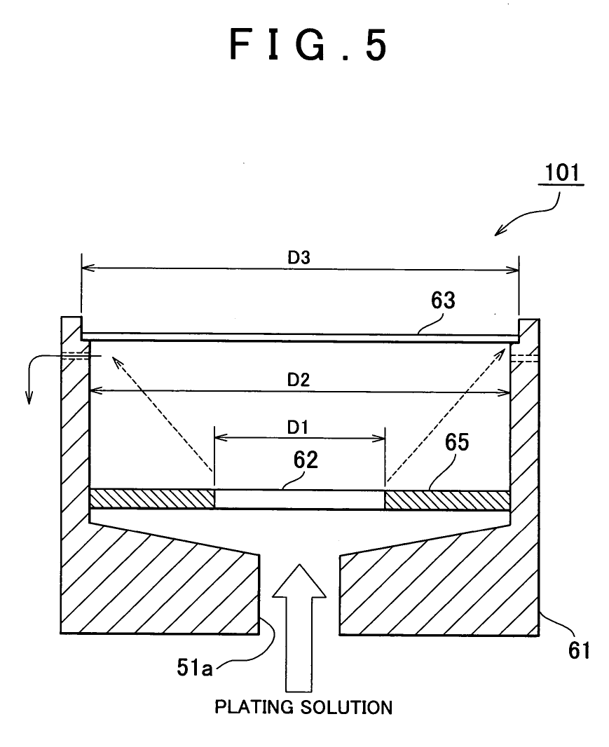

FIG. 5 is a cross sectional view showing a plating solution bath according to a second preferred embodiment of the present invention. A plating solution bath 101 is capable to contain a plating solution therein. The plating solution bath 101 includes a main body 61, and an inflow port 51a. The plating solution is supplied from the inflow port 51a into the plating solution bath so that the plating solution flows through an anode electrode 62 toward a semiconductor wafer 63.

The anode electrode 62 is shaped to be a disk to have an effective diameter D1 that is smaller than an inner diameter D2 of the plating solution bath and smaller than a diameter D3 of the wafer 63. The anode electrode 62 is supported by an electrode holder 65 at the center of the bath 101. The actual diameter D1 of the anode electrode 62 may be about one third of the diameter D3 of the wafer 63.

The main body 61 can be made of a synthetic resin called polytetrafluoroethylene (Teflon) or polyvinyl chloride. The anode electrode 62 can be made of a phosphorus-containing copper or platinum. The wafer 63 is functioning as a cathode electrode in a plating process.

According to the above-described second preferred embodiment, a distance of an electric field between the anode electrode 62 and the outer peripheral (peripheral edge) of the semiconductor wafer 63 is larger than that between the anode electrode 62 and the center of the semiconductor wafer 63. As a result, the amount of metal ions forwarding to the outer peripheral (peripheral edge) of the semiconductor wafer 63 is reduced, and therefore; a uniform thickness of plating can be realized on the entire surface of the semiconductor wafer 63. Further, the anode 62 is formed to be smaller in size as compared with a conventional one, so that a fabrication cost of the apparatus can be lowered.

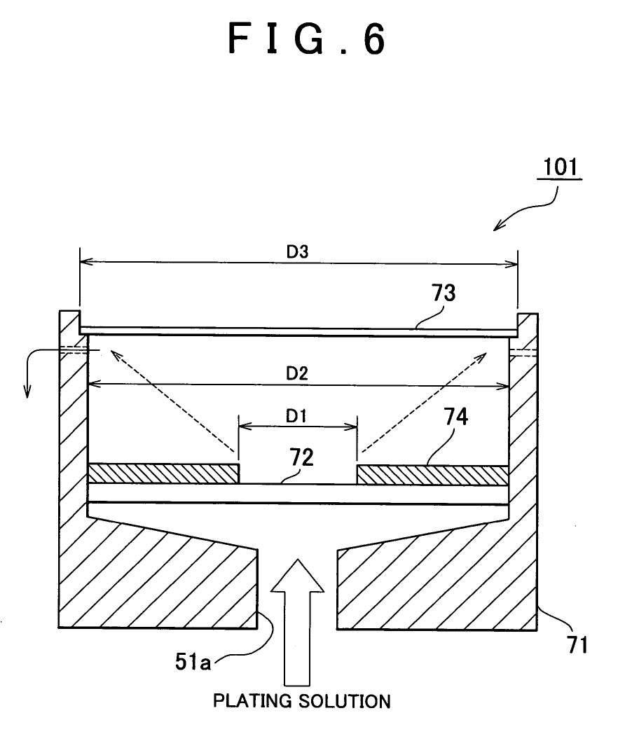

FIG. 6 is a cross sectional view showing a plating solution bath according to a third preferred embodiment of the present invention. A plating solution bath 101 is capable to contain a plating solution therein. The plating solution bath 101 includes a main body 71, an inflow port 51a, and an anode mask 74. The anode mask 74 is made of an insulation material and is arranged onto a surface of an anode electrode 72 to narrow an effective diameter D1 of the anode electrode 72 The plating solution is supplied from the inflow port 51a into the plating solution bath so that the plating solution flows through the anode electrode 72 toward a semiconductor wafer 73.

The anode electrode 72 is shaped to be a disk to have an effective diameter D1 that is smaller than an inner diameter D2 of the plating solution bath and smaller than a diameter D3 of the wafer 73. The actual diameter of the anode electrode 72 may be almost same as the inner diameter D2 of the plating solution bath. The effective diameter D1 of the anode electrode 72 may be one third of the diameter D3 of the wafer 73.

The main body 71 can be made of a synthetic resin called polytetrafluoroethylene (Teflon) or polyvinyl chloride. The anode electrode 72 can be made of a phosphorus-containing copper or platinum. The wafer 73 is functioning as a cathode electrode in a plating process.

According to the above-described third preferred embodiment, a distance of an electric field between the anode electrode 72 and the outer peripheral (peripheral edge) of the semiconductor wafer 73 is larger than that between the anode electrode 72 and the center of the semiconductor wafer 73. As a result, the amount of metal ions forwarding to the outer peripheral (peripheral edge) of the semiconductor wafer 73 is reduced, and therefore; a uniform thickness of plating can be realized on the entire surface of the semiconductor wafer 73. Further, the anode 72 is formed to be smaller in size as compared with a conventional one, so that a fabrication cost of the apparatus can be lowered.

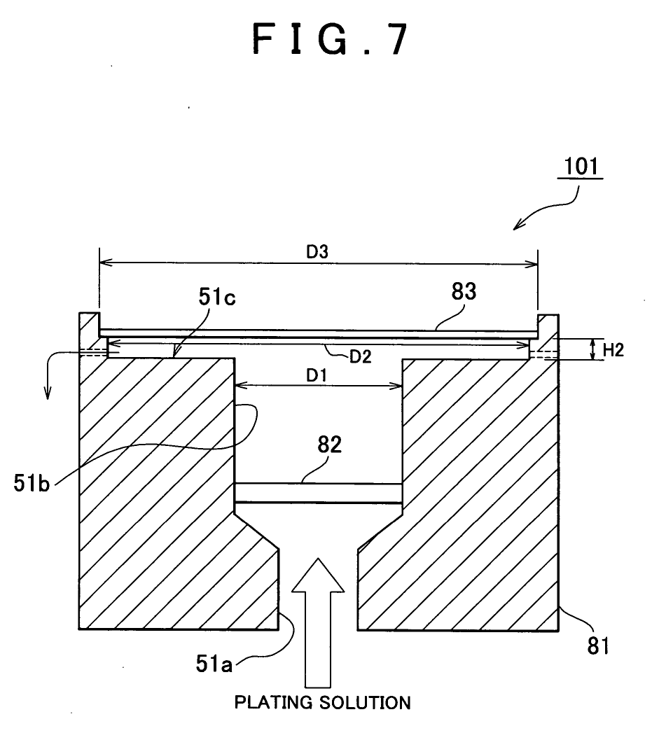

FIG. 7 is a cross sectional view showing a plating solution bath according to a fourth preferred embodiment of the present invention. A plating solution bath 101 is capable to contain a plating solution therein. The plating solution bath 101 includes a main body 81, and an inflow port 51a. The plating solution is supplied from the inflow port 51a into the plating solution bath so that the plating solution flows through the anode electrode 82 toward a semiconductor wafer 83.

The anode electrode 82 may be shaped to be a disk to have an effective but actual diameter D1 that is smaller than an inner diameter D2 of the plating solution bath and smaller than a diameter D3 of the wafer 83. The actual diameter D1 of the anode electrode 82 may be one third of the diameter D3 of the wafer 83.

The main body 81 can be made of a synthetic resin called polytetrafluoroethylene (Teflon) or polyvinyl chloride. The anode electrode 82 can be made of a phosphorus-containing copper or platinum. The wafer 83 is functioning as a cathode electrode in a plating process.

The plating solution bath 101 (81) is shaped to have a first hollow portion 51b having a narrower inner diameter (D1) in which the anode electrode 82 fits. Further, the plating solution bath 101 (81) is shaped to have a second hollow portion 51c directly and closely facing the process surface of the wafer 83. The first hollow portion 51b may have an inner diameter D1 that is about one third of an inner diameter D2 of the second hollow portion 51c.

According to the above-described fourth preferred embodiment, a distance of an electric field between the anode electrode 82 and the outer peripheral (peripheral edge) of the semiconductor wafer 83 is larger than that between the anode electrode 82 and the center of the semiconductor wafer 83. As a result, the amount of metal ions forwarding to the outer peripheral (peripheral edge) of the semiconductor wafer 83 is reduced, and therefore; a uniform thickness of plating can be realized on the entire surface of the semiconductor wafer 83. Further, the anode 82 is formed to be smaller in size as compared with a conventional one, so that a fabrication cost of the apparatus can be lowered.

It should be noted that, in the above description, the same or corresponding components are represented by the same reference numerals and the same description is not repeated.

What is claimed is:

1. A plating apparatus, comprising:
a plating solution bath which is capable to contain a plating solution therein;
a holding mechanism which is capable to hold a wafer so that a processing surface is soaked in the plating solution, contained in the plating solution bath;
a first electrode provided in the plating solution bath;
an inflow port from which the plating solution is supplied into the plating solution bath so that the plating solution flows through the first electrode toward the wafer; and
a power supply which is capable to supply an electric current to be flowing through the plating solution located between the first electrode and wafer, wherein
the plating solution bath comprises a projected inner wall portion, arranged between the first electrode and the wafer, to control an electric field forwarding to the wafer, the projected inner wall portion is formed as a part an inner wall of the plating solution bath in a united body.

2. A plating apparatus according to claim 1, wherein
the projected inner wall portion is shaped to be tapered so that an angles formed between the projected inner wall and a vertical portion of the inner wall of the plating solution bath is larger than 90 degrees.

3. A plating apparatus according to claim 1, wherein
a vertical distance from an open end of the projected inner wall to the wafer is about 15% of a diameter of the wafer.

4. A plating apparatus according to claim 1, wherein
a projecting width of the projected inner wall is about 10% of a diameter of the wafer.

5. A plating apparatus according to claim 1, wherein
a vertical distance from an open end of the projected inner wall to the wafer is about 15% of a diameter of the wafer.
a projecting width of the projected inner wall is about 10% of the diameter of the wafer.

6. A plating apparatus according to claim 1, wherein
at least one of a conductive post and a conductive pattern is formed on the wafer.

7. A plating apparatus, comprising:
a plating solution bath which is capable to contain a plating solution therein;
a holding mechanism which is capable to hold a wafer so that a processing surface is soaked in the plating solution, contained in the plating solution bath;
a disk shape of anode electrode provided in the plating solution bath;
an inflow port from which the plating solution is supplied into the plating solution bath so that the plating solution flows through the anode electrode toward the wafer; and
a power supply which is capable to supply an electric current to be flowing through the plating solution located between the anode electrode and wafer, wherein
the anode electrode has an effective diameter that is smaller than an inner diameter of the plating solution bath.

8. A plating apparatus, according to claim 7, further comprising:
an electrode holder which holds the anode electrode at its center.

9. A plating apparatus, according to claim 7, wherein
an actual diameter of the anode electrode is smaller than an diameter of the wafer.

10. A plating apparatus, according to claim 8, wherein
an actual diameter of the anode electrode is about one third of the wafer.

11. A plating apparatus, according to claim 7, further comprising:
an anode mask which is of an insulation material and is arranged onto a surface of the anode electrode to narrow an effective diameter of the anode electrode.

12. A plating apparatus, according to claim 11, wherein
the effective diameter of the anode electrode is smaller than an diameter of the wafer.

13. A plating apparatus, according to claim 12, wherein
the effective diameter of the anode electrode is about one third of the wafer.

14. A plating apparatus, according to claim 7, wherein
the plating solution bath is shaped to have a first hollow portion having a narrower inner diameter in which the anode electrode fits.

15. A plating apparatus, according to claim 14, wherein
the plating solution bath is shaped to have a second hollow portion facing the process surface of the wafer.

16. A plating apparatus, according to claim 7, wherein
the plating solution bath is shaped to have a first hollow portion having a narrower inner diameter in which the anode electrode fits, and a second hollow portion facing the process surface of the wafer.

17. A plating apparatus, according to claim 14, wherein
the first hollow portion has an inner diameter that is smaller than an diameter of the wafer.

18. A plating apparatus, according to claim 17, wherein
the first hollow portion has an inner diameter that is about one third of an inner diameter of the second hollow portion.

19. A plating solution bath used in a plating apparatus according to claim 1.
